(19) United States
(12) Patent Application Publication
(10) Pub. No.: US 2010/0172131 A1
(43) Pub. Date: Jul. 8, 2010

(54) LED street lamp

(76) Inventors: Yun-Chiang Mo, Hsinchu (TW); Chia-Hua Liao, Hsinchu (TW); Yi-Chun Chen, Hsinchu (TW); Yen-Yu Huang, Hsinchu (TW); Chia-Hsiang Chuang, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/318,616

(22) Filed: Jan. 2, 2009

(51) Int. Cl. F21V 29/00

(52) U.S. Cl. 362/234

(57) ABSTRACT

A light-emitting diode (LED) street lamp is applicable for street lighting. The LED street lamp includes a casing, an LED module, and a heat dissipation module. The LED module and the heat dissipation module are arranged inside the casing. The LED module includes a frame, a circuit board carrying a plurality of LEDs, and a light regulation mechanism. The frame and the circuit board are set opposing each other with the light regulation mechanism arranged therebetween to interfere with emission light from the LEDs. The emission light, after being interfered with, is projected outside the casing to realize lighting. The heat dissipation module is in physical engagement with the LED module to remove heat generated by the LEDs. As such, the LED street lamp is provided with a broader range of illumination angle and more uniform brightness, so that the same LED street lamp is applicable to various sites and the heat generated by the LEDs can be efficiently dissipated.

### FIELD OF THE INVENTION

The present invention relates to a light-emitting diode (LED) street lamp, and in particular to a LED street lamp that comprises an LED module that contains therein a light regulation mechanism and that is applicable for street lighting.

### BACKGROUND OF THE INVENTION

Due to the advantages of high brightness and power saving, light-emitting diodes (LEDs) are widely used in various lighting devices, of which an example is an LED street lamp for street lighting.

However, the LED street lamp may be set at different heights for illumination at different sites. For example, a LED street lamp in a park has a quite different height of installation from that in an ordinary street. Different illumination height of the LED street lamp affects the illumination angle and brightness uniformity of the LED street lamp. The state-of-the-art LED street lamp is generally incapable of adjustment of illumination angle and brightness uniformity in accordance with different sites of installation.

On the other hand, due to the poor heat resistance of the LEDs, the heat generated by the LEDs during thereof operation must be dissipated by employing a heat dissipation device so as to maintain the LEDs in a proper temperature range for giving off light without being burnt down. The state-of-the-art heat dissipation device for an LED street lamp is of an insufficient capability for removing heat, and thus often leading to burn-down of the LEDs of the LED street lamp or shortening of the lifespan thereof. This is even server for recently developed high power LEDs of which the even greater amount of heat cannot be effectively removed by the state-of-the-art heat dissipation device for LED street lamps.

### SUMMARY OF THE INVENTION

An objective of the present invention is to employ a special arrangement of a light-emitting diode (LED) module and a light regulation mechanism set in the LED module to adjust the illumination light of an LED street lamp in accordance with various needs so as to make the illumination angle of the illumination light broader and the brightness of the illumination light more uniform, thereby allowing the same LED street lamp to be applicable to various sites.

Another objective of the present invention is to employ a special arrangement of a heat dissipation module to provide enhanced heat dissipation performance so that the heat generated by LEDs can be efficiently dissipated to protect the LEDs from being burnt down and to increase the lifespan of the LEDs.

A further objective of the present invention is to employ a heat dissipation arrangement to enhance the overall heat dissipation performance for an LED street lamp.

To realize the above objectives, the present invention provides an LED street lamp that comprises a casing, an LED module, and a heat dissipation module. The LED module and the heat dissipation module are arranged inside the casing. The LED module comprises a frame, a circuit board carrying a plurality of LEDs, and a light regulation mechanism. The frame and the circuit board are set opposing each other and the light regulation mechanism is arranged between the frame and the circuit board to interfere with emission light from the LEDs. The emission light, after being interfered with, is projected outside the casing. The heat dissipation module is in physical engagement with the LED module for heat transfer.

The light regulation mechanism of a first embodiment of the LED module comprises a plurality of reflector plates, at least one control element, and a link bar. Each reflector plate has two opposite ends each having a central position and an eccentric position. Each reflector plate is arranged between and pivotally mounted to two opposite inside surfaces of the frame through the central positions of the ends thereof. The control element has a pivot axle coupled to the central position of one of the ends of one of the reflector plates. The control element is operable to rotate the reflector plate through the coupling between the pivot axle and the central position. Further, one of the ends of each reflector plate is pivotally coupled, at the eccentric position thereof, to a corresponding position of the link bar, so that the reflector plates are simultaneously operable through being simultaneously driven by the link bar.

The light regulation mechanism of a second embodiment of the LED module comprises a plurality of reflector plates and the LEDs are arranged in a row by row manner to form a plurality of LED rows on the circuit board. Each LED row has a right-hand side and a left-hand side at each of which a reflector plate is set. The reflector plates are set on the circuit board and each has a height to allow emission light from one of a left-side adjacent LED row and a right-side adjacent LED row thereof to pass.

The heat dissipation module comprises at least one heat dissipation body and a plurality of heat pipes. The heat dissipation body has a base and a plurality of heat dissipation fins formed on the base. The heat pipes connect between the base of the heat dissipation body and the circuit board of the LED module. The circuit board is made of a heat-transmittable material to transfer heat from the LEDs through the heat pipes to the heat dissipation body.

The LED street lamp of the present invention has other heat dissipation features, including a plurality of heat dissipation slots and a plurality of lateral side heat dissipation holes formed in the casing and the heat dissipation module being set in physical engagement with the aluminum-made casing for enhancing the overall heat dissipation.

### BRIEF DESCRIPTION OF THE DRAWINGS

The present invention will be apparent to those skilled in the art by reading the following description of preferred embodiments thereof with reference to the drawings, in which:

FIG. 1 is a perspective view of a light-emitting diode (LED) lamp constructed in accordance with the present invention;

FIG. 2 is an exploded view of the LED street lamp in accordance with the present invention;

FIG. 3 is an exploded view of a first embodiment of an LED module of the LED street lamp of the present invention;

FIG. 4 is a partial cross-sectional view illustrating a combination of the LED module and a heat dissipation module of the LED street lamp in accordance with the present invention before being operated;

FIG. 5 is a cross-sectional view of the combination of the LED module and the heat dissipation module of the LED-street lamp in accordance with the present invention after being operated;

FIG. 6 is an exploded view of a second embodiment of the LED module of the LED street lamp in accordance with the present invention;

FIG. 7 is a side elevational view of a circuit board of the second embodiment LED module of the LED street lamp in accordance with the present invention;

FIG. 8 is a schematic view illustrating the principle of a light regulation mechanism of the second embodiment LED module of the LED street lamp in accordance with the present invention;

FIG. 9 is another schematic view illustrating the principle of the light regulation mechanism of the second embodiment LED module of the LED street lamp in accordance with the present invention; and

FIG. 10 is a top plan view of a casing of the LED street lamp in accordance with the present invention.

### DETAILED DESCRIPTION OF THE PREFERRED EMBODIMENTS

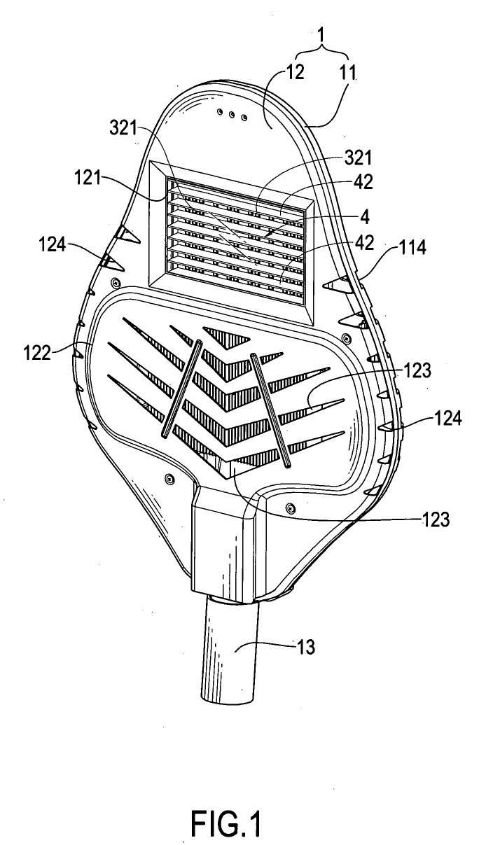

The present invention provides a light-emitting diode (LED) street lamp applicable to street lighting. An example of the LED street lamp is illustrated in FIG. 1, forming an opening 121 that serves as a light emission surface of the LED street lamp and faces down toward the street to be illuminated in a practical application. Further, the LED street lamp also comprises a lamp post that is perpendicularly fixed to the street. FIG. 1 shows a connection portion 13 that serves to connect to the lamp post. However, to simplify the illustration, the lamp post is omitted in all the drawings.

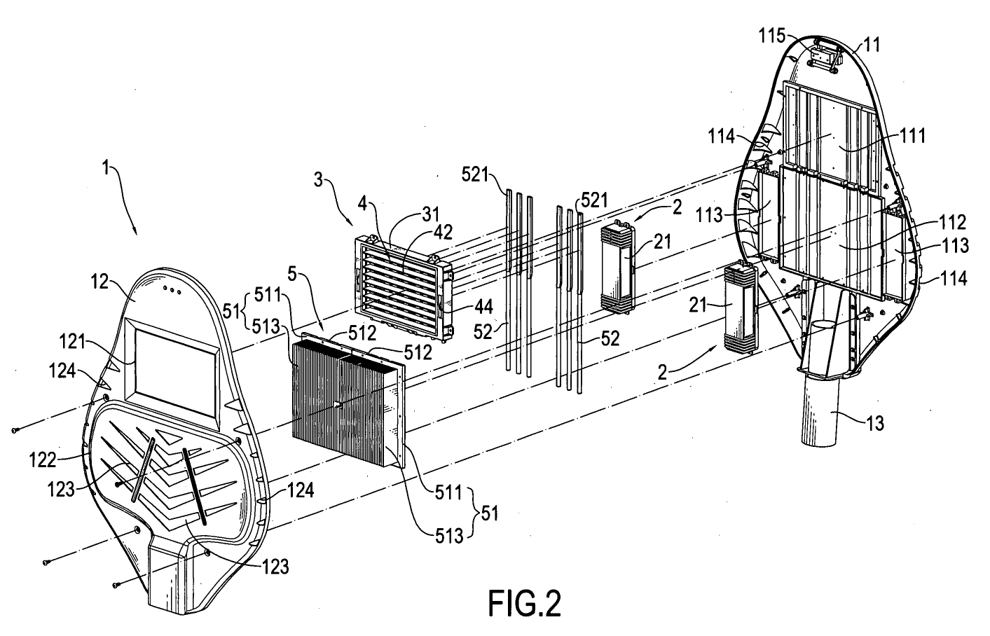

With reference to FIGS. 1 and 2, the LED street lamp comprises a casing 1, a pair of power supply devices 2, an LED module 3, a light regulation mechanism 4, and a heat dissipation module 5.

The casing 1 comprises first and second casing members 11, 12 that mate each other. The first casing member 11 has an inside surface in which first, second, and third positioning zones 111, 112, 113 are defined. The first casing member 11 has a rear end portion that forms the connection portion 13. The second casing member 12 has an upper section forming the opening 121 and a lower section forming a raised portion 122 that bulges outward beyond an outside surface of the second casing member and corresponds in position to the heat dissipation module 5. The raised portion 122 forms a plurality of heat dissipation slots 123. The first and second casing members 11, 12 have circumferential portions in which heat dissipation holes 114, 124 are defined. Pivotal joint means 115 is formed between the first and second casing members at a front end of the inside surfaces thereof, so that the second casing member 12 is rotatable about the pivotal joint means 115 to selectively open and/or close.

The power supply devices 2 are respectively set on the third positioning zones 113 of the first casing member 11 and the power supply devices 2 are housed in heat-transmittable enclosures 21.

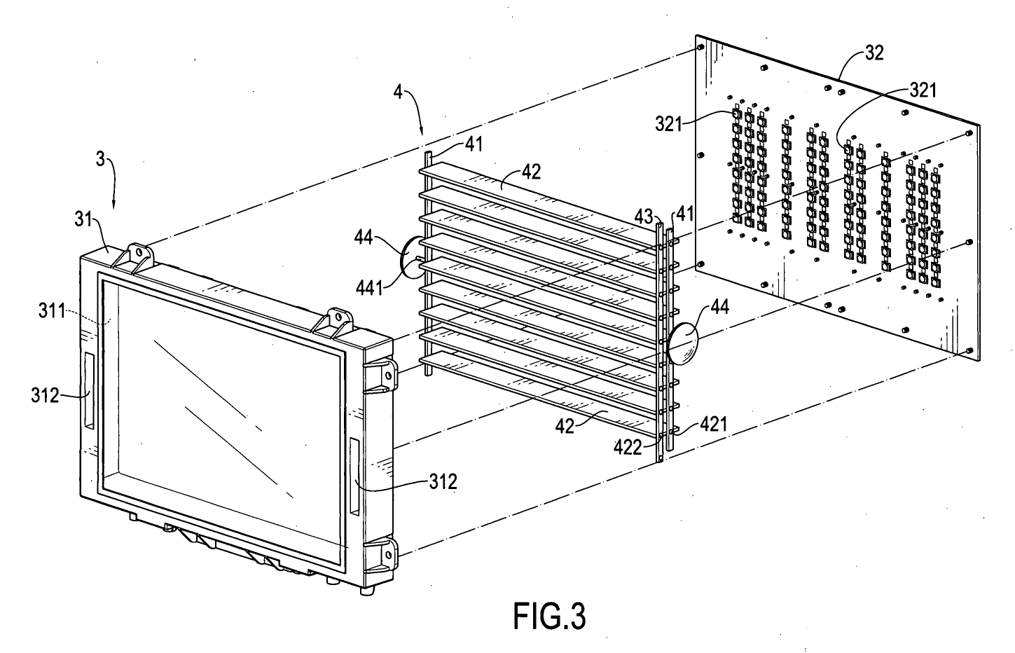

The LED module 3 is set in the first positioning zone 111 of the first casing member 11. Also referring to FIG. 3, the LED module 3 comprises a frame 31, a circuit board 32 that carries a plurality of LEDs 321, and the light regulation mechanism 4. The frame 31 and the circuit board 32 are set to oppose and fix to each other. The light regulation mechanism 4 is arranged between the frame 31 and the circuit board 32 to interfere with emission light from the LEDs 321. The emission light, after being interfered with, is allowed to emit out of the casing 1 through the opening 121 of the second casing member 12.

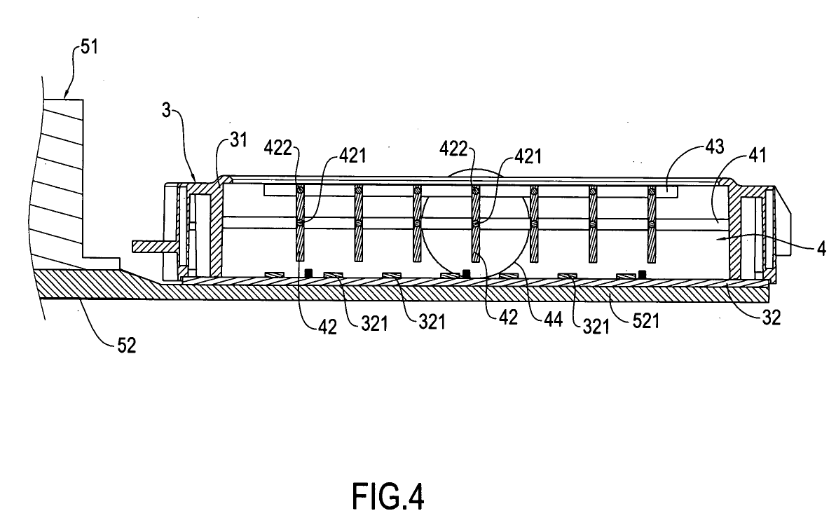

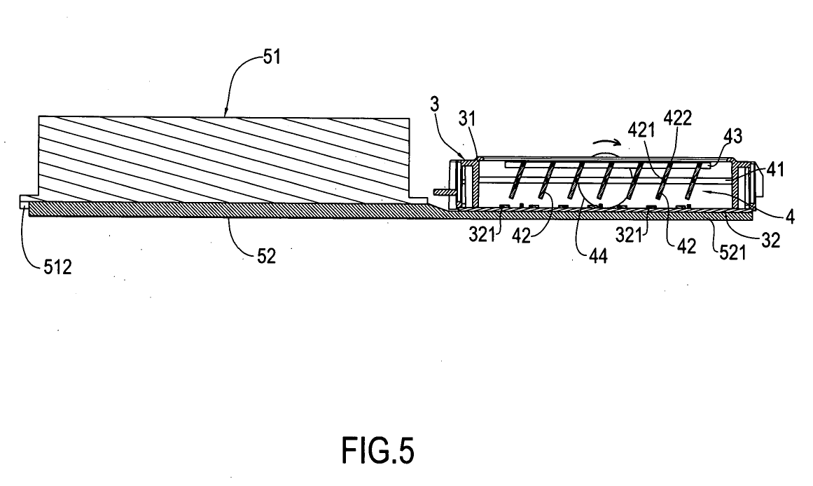

Reference is now made to a first embodiment of the LED module 3 shown in FIGS. 3 and 4. The frame 31 of the LED module has a front side to which a light-transmitting board (not labeled) is attached. The light regulation mechanism 4 is set between the frame 31 and the circuit board 32. The light regulation mechanism 4 comprises a pair of support racks 41, a plurality of reflector plates 42, a link bar 43, and at least one control element 44. In the embodiment shown in FIG. 3, two roller-like control elements 44 are provided. Each reflector plate 42 has two opposite ends each having a central position 421 and an eccentric position 422. Each reflector plate 42 is arranged between and pivotally mounted to the support racks 41 through the central positions 421 of the ends thereof. The two control elements 44 each have a pivot axle 441 and the two pivot axles 441 are respectively coupled to the central positions 421 of the two ends of one of the reflector plates 42, whereby the control elements 44 may be used to rotate said one of the reflector plates 42. Further, each reflector plate 42 is pivotally coupled, through the eccentric position 422 of one end thereof, to a corresponding location of the link bar 43, whereby all the reflector plates 42 can be synchronously operated by being driven by the link bar 43 to realize simultaneous rotation of all the reflector plates 42 (as shown in FIG. 5). In other words, the reflector plates 42 can be controlled to rotate simultaneously by operating the control elements 44. The pair of support racks 41 is mounted to opposite inside surfaces 311 of the frame 31 respectively to set the light regulation mechanism 4 between the frame 31 and the circuit board 32. However, although not illustrated, it is apparent that the reflector plates 42 of the light regulation mechanism 4 can be directly pivoted between the two opposite inside surfaces 311 of the frame 31 so as to omit the pair of support racks 41.

As shown in the drawings, the frame 31 also forms two openings 312 corresponding to the two control elements 44 whereby the two control elements 44 can extend through the two openings 312 to partially expose outside the frame 31.

When the emission light from the LEDs 321 travels through the light regulation mechanism 4, the emission light is subjected to interference by the reflector plates 42 so as to be guided to form a broad range of illumination angle and to provide more uniform illumination brightness.

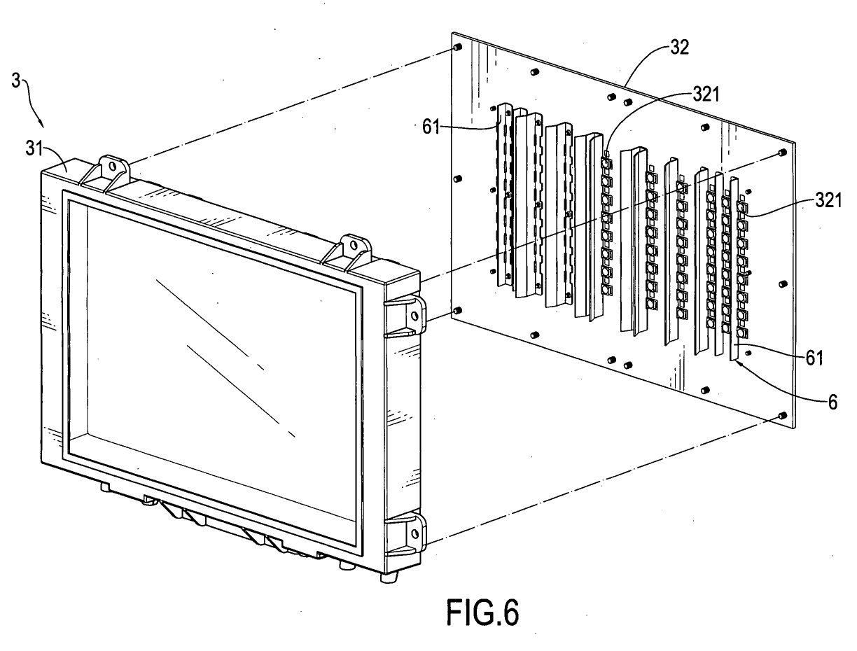

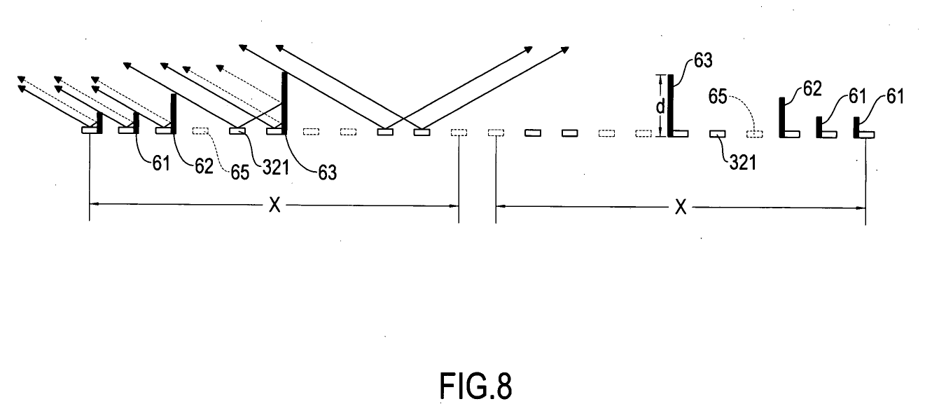

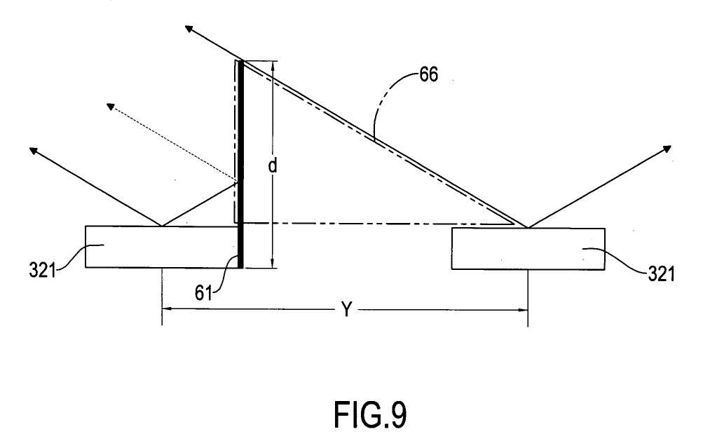

Reference is now made to a second embodiment of the LED module 3 illustrated in FIG. 6. The second embodiment LED module 3 comprises a light regulation mechanism 6 that is arranged between the frame 31 and the circuit board 32 and the circuit board 32 carries a plurality of LEDs 32 that is arranged in a row by row manner so as to form multiple rows of LEDs on the circuit board 32. Since this arrangement makes illumination that is brighter in a middle portion but darker in opposite side portions, the interference of light realized by the light regulation mechanism 6 is employed to provide light compensation for the opposite side portions. As shown in FIG. 8, the light regulation mechanism 6 comprises a plurality of reflector plates 61 for light compensation. To prevent excessive brightness after the compensation of light, at least one of the LED rows is selectively set as vacant row, such as row 65 for consideration of brightness. To not shield the emission light of the adjacent LED row, the reflector plates, such as reflector plates 61, 62, 63, are arranged to have different heights for allowing the light to pass over the reflector plates. The height d of a particular reflector plate can be determined as illustrated in FIG. 9, where a distance Y between two adjacent LEDs 321 is known, and the height and the illumination angle of the LEDs 321 are also known, whereby a triangle 66, as shown in phantom lines in FIG. 9, is formed. The height of the reflector plate 61 that allows the emission light from the adjacent LED 321 to pass can then be calculated with the trigonometry.

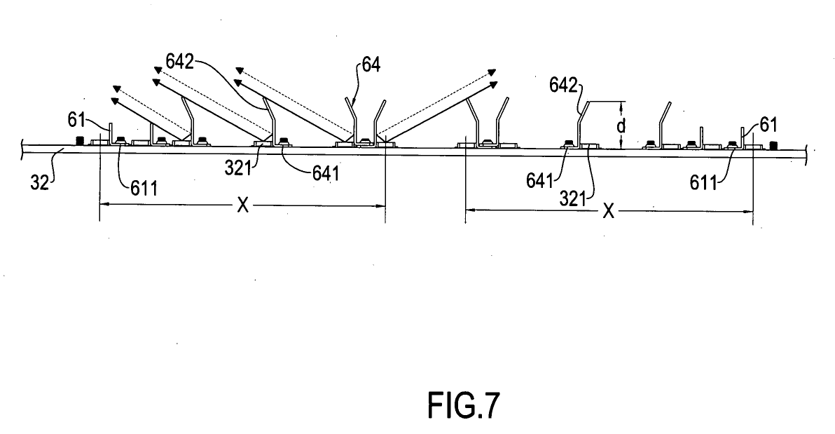

Accordingly, as shown in FIGS. 6 and 7, the light regulation mechanism 6 of the second embodiment comprises the plurality of reflector plates 61 and the LED rows that are set on the circuit board 32 are divided into a left-hand side block and a right-hand side block. The distance X of the left-hand side block is set equal to the distance X of the right-hand side block. Taking the left-hand side block as an example, each LED row has a reflector plate 61 arranged at the right-hand side thereof and each reflector plate 61 is mounted to the circuit board 32 as shown in FIG. 7. Each reflector plate 61 has a height d that allows the emission light from the adjacent LED row at the right-hand side thereof to pass. For the right-hand side block, the arrangement is exactly opposite to that of the left-hand side block, whereby each LED row of the right-hand side block has a reflector plate 61 set at the left-hand side thereof and the reflector plate 61 has a height d that allows the emission light from the adjacent LED row at the left-hand side thereof to pass. In this way, the light of the left-hand side block is guided to converge toward the left-hand side to realize left-hand side light compensation; also, the light of the right-hand side block is guided to converge toward the right-hand side to realize right-hand side light compensation. Consequently, light in the left and right hand sides can be compensated to be of substantially identical brightness or nearly identical brightness of the middle portion. This is the effect to be achieved by the second embodiment of the LED module 3.

The reflector plates 61, 62, 63 of the second embodiment, as shown in FIG. 8, are made in a linear form. However, as shown in FIG. 7, the reflector plates 64 can be alternatively shaped to provide better guidance for light. The reflector plate 64 has first and second edges that are opposite to each other. The first edge forms a fixing section 641 that is fixed to the circuit board 32, while the second edge forms an inclined section that is inclined leftward or rightward. The reflector plate 64 belonging to the left-hand side block is made to have the inclined section 642 thereof inclined leftward, while the reflector plate 64 belonging to the right-hand side block is made to have the inclined section 642 thereof inclined rightward. In this way, the effect of light compensation can be further enhanced. As shown in FIG. 7, the reflector plates that are provided with an inclined section 642 are preferably those reflector plates 64 that have large heights; and for those reflector plates 61 with small heights, only the fixing section 611 for mounting purposes is provided.

Referring to FIG. 2, the heat dissipation module 5 is set in the second positioning zone 112 of the first casing member 11 and the in physical engagement with the LED module 3 for heat transfer. The heat dissipation module 5 comprises at least one heat dissipation body 51 (two heat dissipation bodies being shown in the drawings) and a plurality of heat pipes 52. Each heat dissipation body 51 comprises a base 511 and a plurality of heat dissipation fins 513 formed on the base 511. The heat pipes 52 connect between the bases 511 of the two heat dissipation bodies 51 and the circuit board 32 of the LED module 3 to allow the circuit board 32 that is made of a heat-transmittable material to transmit the heat generated by the LEDs 321 through the heat pipes 52 to the heat dissipation bodies 51.

A preferred arrangement as shown in FIGS. 2 and 5 is that the heat dissipation body 51 forms in a bottom face thereof grooves 512 and the circuit board 32 is made of a high heat conduction aluminum substrate and a front section 512 of each heat pipe 52 is made flat for being positionable against a bottom surface of the circuit board 32. Thus, each heat pipe 52 can be positioned against the bottom surface of the aluminum substrate with the front flat section 512 thereof. The bottom face of the base 511 of each heat dissipation body 51 forms a plurality of grooves 512 corresponding to the heat pipes 52 so that a rear section of each heat pipe 52 is received in a corresponding groove 512. In this way, the aluminum substrate circuit board 32 can efficiently transfer the heat generated by the LEDs 321 through the heat pipes 52 to the heat dissipation bodies 51 for heat dissipation and enhanced heat dissipation performance is achieved.

Further, outer edges of the heat dissipation fins 513 of the heat dissipation bodies 51 can be selectively set in physical engagement with an inside surface (not shown) of the second casing member 12 and the casing 1 that is comprised of the first and second casing members 11, 12 is made of a high heat conduction material, such as aluminum, whereby the heat accumulated in the heat dissipation bodies 51 can be effectively transferred to the whole casing 1 for even improved heat dissipation performance.

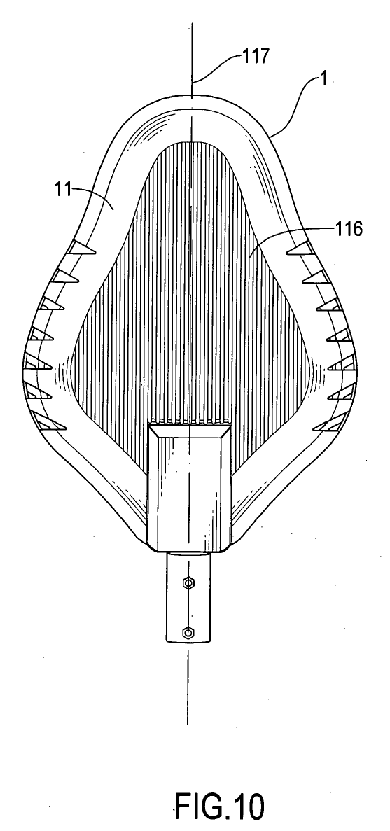

Referring to FIG. 10, since the first casing member 11 of the casing 1 is oriented toward the sky, dust may easily accumulated thereon, leading to deterioration of heat dissipation of the casing 1. Thus, the first casing member 11 is made in such a way that opposite side portions thereof that are formed by dividing the first casing member 11 along a central line 117 are made inclined downward to form a curved ridge configuration (not shown) that is raised in the middle portion and the height of the opposite side portions is gradually reduced toward the edges. Further, an outside surface (that faces the sky) of the first casing member 11 forms a plurality of raised patterns 116 to provide an effect of not allowing dust to retain thereon.

The features of the LED street lamp of the present invention are (1) that the arrangement of the LED module 3 and the light regulation mechanism 4 allows the emission light of the LED street lamp to be adjusted in accordance with various needs, making the range of the illumination angle of the emission light broader and the brightness of the emission light more uniform, whereby the same LED street lamp can be installed at various sites; (2) that the special configuration of the heat dissipation module 5 allows the heat generated by the LEDs to be efficiently dissipated away for protecting the LEDs from being burnt down and thereby increasing the lifespan of the LEDs; and (3) that other heat dissipation features, including the numerous heat dissipation slots and lateral side heat dissipation holes formed in the aluminum-made casing 1 and the heat dissipation module 5 being set in physical engagement with the aluminum-made casing 1 for enhancing the overall heat dissipation, further improve the overall heat dissipation of the LED street lamp.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A light-emitting diode (LED) street lamp, comprising:
a casing;
an LED module, which is arranged inside the casing, comprising a frame, a circuit board carrying a plurality of LEDs, and a light regulation mechanism, the frame and the circuit board being set to oppose each other, the light regulation mechanism being arranged between the frame and the circuit board to interfere with emission light from the LED, the emission light, after being interfered with, being allowed to emit out of the casing; and
a heat dissipation module, which is arranged inside the casing and is set in physical engagement with the LED module for heat transfer.

2. The LED street lamp as claimed in claim 1, wherein the light regulation mechanism of the LED module comprises:
a plurality of reflector plates, each reflector plate having two opposite ends each having a central position and an eccentric position, each reflector plate being arranged between and pivotally mounted to two opposite inside surfaces of the frame through the central positions of the ends thereof;
at least one control element, which has a pivot axle coupled to the central position of one of the ends of one of the reflector plates, the control element being operable to rotate the reflector plate through the coupling between the pivot axle and the central position; and
a link bar, which has a portion to which the eccentric position of one of the ends of each reflector plate is pivotally coupled so that the reflector plates are simultaneously operable through being simultaneously driven by the link bar.

3. The LED street lamp as claimed in claim 1, wherein the light regulation mechanism of the LED module comprises:
a pair of support racks, which are respectively fixed to two opposite inside surfaces of the frame;
a plurality of reflector plates, each reflector plate having two opposite ends each having a central position and an eccentric position, each reflector plate being arranged between and pivotally mounted to the pair of support racks through the central positions of the ends thereof;
at least one control element, which has a pivot axle coupled to the central position of one of the ends of one of the reflector plates, the control element being operable to rotate the reflector plate through the coupling between the pivot axle and the central position; and
a link bar, which has a portion to which the eccentric position of one of the ends of each reflector plate is pivotally coupled so that the reflector plates are simultaneously operable through being simultaneously driven by the link bar.

4. The LED street lamp as claimed in claim 1, wherein the light regulation mechanism of the LED module comprises a plurality of reflector plates and wherein the LEDs are arranged in a row by row manner to form a plurality of LED rows on the circuit board, each LED row having a right-hand side and a left-hand side at each of which one of the reflector plates is set, the reflector plates being set on the circuit board and each having a height to allow emission light from one of a left-side adjacent LED row and a right-side adjacent LED row thereof to pass.

5. The LED street lamp as claimed in claim 4, wherein the LEDs carried on the circuit board are divided into a left-hand side block and a right-hand side block and wherein each reflector plate included in the left-hand side block has a height that allows the emission light of the right-side adjacent LED row thereof to pass and each reflector plate included in the right-hand side block has a height that allows the emission light of the left-side adjacent LED row thereof to pass.

6. The LED street lamp as claimed in claim 4, wherein the LEDs carried on the circuit board are divided into a left-hand side block and a right-hand side block and wherein the reflector plate has opposite first and second edges, the first edge being fixed to the circuit board, the second edge forming an inclined section that is inclined leftward or rightward, the inclined section of the reflector plate included in the left-hand side block being inclined leftward, the inclined section of the reflector plate included in the right-hand side block being inclined rightward.

7. The LED street lamp as claimed in claim 4, wherein at least one of the LED rows is selectively a vacant row for brightness consideration.

8. The LED street lamp as claimed in claim 1, wherein the heat dissipation module comprises:
at least one heat dissipation body, which has a base and a plurality of heat dissipation fins formed on the base; and
a plurality of heat pipes, which connect between the base of the heat dissipation body and the circuit board of the LED module, the circuit board being made of a heat-transmittable material to transfer heat from the LEDs through the heat pipes to the heat dissipation body.

9. The LED street lamp as claimed in claim 8, wherein the base of the heat dissipation body has a bottom face forming a plurality of grooves respectively corresponding to the heat pipes, each heat pipe having a rear section received in a corresponding one of the grooves.

10. The LED street lamp as claimed in claim 8, wherein the circuit board comprises an aluminum substrate, each heat pipe having a front section positioned against a bottom surface of the aluminum substrate.

11. The LED street lamp as claimed in claim 10, wherein the front section of the heat pipe is made flat for easy positioning.

12. The LED street lamp as claimed in claim 8, wherein the heat dissipation fins of the heat dissipation body are in physical engagement with an inside surface of the casing and wherein the casing is made of aluminum for heat dissipation.

13. The LED street lamp as claimed in claim 1, wherein the casing comprises first and second casing members that mate each other, the first casing member being made to incline toward opposite edges from a central line to form a curved ridge configuration that is raised in a middle portion and a height of the opposite side portions being gradually reduced toward the edges, the first casing member having an outside surface forming a plurality of raised patterns.

14. The LED street lamp as claimed in claim 1, wherein the casing comprises first and second casing members that mate each other, the second casing member forming an opening corresponding to the LED module to allow emission light from the LED module to project outside the casing through the opening.

15. The LED street lamp as claimed in claim 1, wherein the casing forms a plurality of heat dissipation slots corresponding to the heat dissipation module.

16. The LED street lamp as claimed in claim 1, wherein the casing forms a plurality of heat dissipation holes along a circumference thereof.

17. The LED street lamp as claimed in claim 1 further comprising at least one power supply device that is arranged inside the casing, the power supply device being housed in a heat-transmittable enclosure.
